(19) United States
(12) Patent Application Publication
(10) Pub. No.: US 2012/0226588 A1
(43) Pub. Date: Sep. 6, 2012

(54) eGift Social Platform

(75) Inventors: Chris Wuhrer, Alexandria, VA (US); Jerome Myers, Douglasville, GA (US); Sarah Owen, Atlanta, GA (US); Caryn L. Dixon, Mount Juliet, TN (US); Sameer S. Bharwani, Centennial, CO (US); J. Scott Sanchez, Atlanta, GA (US); Pranav Kariwala, Sandy Springs, GA (US); Jigar Desai, Atlanta, GA (US); Yinchuan Tan, Atlanta, GA (US)

(73) Assignee: First Data Corporation, Greenwood Village, CO (US)

(21) Appl. No.: 13/341,158

(22) Filed: Dec. 30, 2011

Related U.S. Application Data
(60) Provisional application No. 61/428,434, filed on Dec. 30, 2010.

(51) Int. Cl. G06Q 30/06

(52) U.S. Cl. 705/27.1

(57) ABSTRACT

Systems and methods for electronic commerce using a dynamic checkout and/or group gifting are provided. The dynamic checkout process can be integrated with a social platform electronic commerce experience allowing a user to select a single gift, multiple gifts, and/or to create a basket of goods to send to one or multiple recipients. The dynamic checkout allows the user to select the desired recipient(s) before, after, or intermixed with selecting the offers and/or creating the basket of goods. These offers or products can be purchased by the user with a single payment which will be appropriately apportioned to the merchants based on the products purchased. Once the payment has been successfully processed, an electronic delivery or a physical delivery of the goods or products will occur.

### CROSS-REFERENCE TO RELATED APPLICATIONS

This application claims the benefit of U.S. Provisional Application No. 61/428,434 filed on Dec. 30, 2010 entitled “eGift Social Platform” which is hereby incorporated by reference for all purposes in its entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2010-2011 First Data Corporation.

### TECHNICAL FIELD

Various embodiments of the present invention generally relate to electronic commerce. More specifically, various embodiments of the present invention relate to a dynamic checkout and/or group gifting within a social platform.

### BACKGROUND

With the proliferation of the Internet, there has been a significant increase in the buying and selling of products over the Internet. Electronic commerce is a term used to describe online business transactions that are conducted over the Internet. Electronic commerce can be between two businesses or between a business and a customer. To support the electronic commerce transactions between two businesses or between a business and a customer, a variety of applications are commonly utilized. Examples of the applications commonly utilized include, e-mail, chat windows, instant messaging, electronic fund transfers, credit/debit card processing, on-line advertising, shopping carts, data management, Web services, and others.

There are a number of challenges and inefficiencies created in traditional electronic commerce shopping carts and checkout applications. For example, traditional electronic commerce shopping carts and checkout applications have significant limitations that can result in the user unnecessarily repeating a similar shopping experience. Thus, it can be difficult for the user to efficiently purchase the desired products provided by the business or merchant.

### SUMMARY

Systems and methods are described for electronic commerce using a dynamic checkout within an ecommerce environment leveraging various subsystems (e.g., mobile device, a social platform, etc.). In some embodiments, a method comprises displaying an interactive product list that includes a plurality of gifts (e.g., a physical item, a physical or virtual card that has monetary value or is redeemable via a point of sale at one or more merchants, a service, a gift certificate redeemable at one or more merchants, a coffee product, an ice cream product, a music download, and/or movie tickets) that can be purchased by a user. Selection information can be received identifying multiple recipients to which the user desires to send one or more gifts. Each of the multiple recipients can be associated with at least one gift selected by the user through the interactive product list. In some embodiments, a checkout request can be processed to purchase the gifts associated with each of the multiple recipients using a single credit card transaction. The gifts can then be distributed electronically (e.g., through a mobile phone, an internet-based social networking site, and/or an e-mail address) to the multiple recipients upon approval of the single credit card transaction.

In some embodiments, the multiple recipients are members of an internet-based social networking site and electronically distributing the gifts occurs through the social networking site. In some cases, the gifts electronically distributed to the multiple recipients can be from at least two different merchants. As a result, processing the checkout request includes apportioning payment to the at least two different merchants.

Various embodiments of the method also include presenting a rendering option to each of the multiple recipients. The rendering options that are available and presented to the user can be based on a merchant associated with the gift, the gift, the recipient, and/or other factors. Examples of rendering options include, but are not limited to a 2-D barcode, a sixteen digit number, association with an existing gift card, or association with a contactless device. Once a selection is received, the electronically distributed gifts can be rendered in the rendering option selected.

One or more embodiments allow for an on-demand provisioning. For example, once an on-demand provisioning request is received from one of the multiple recipients to provision one of the gifts from a first format into a second format, the request can be processed.

According to some embodiments, a system is provided that include a merchant database, a graphical user interface module, a dynamic checkout module, and a delivery module. In other embodiments, the system can also include a recipient search module, a social media platform, a product module, a message module, and/or an on-demand rendering module.

The merchant database can store a plurality of gifts that are each associated with (i.e., available for purchase from) a merchant. The graphical user interface module can generate one or more user interface screens to receive user input to associate multiple recipients with one or more of the plurality of gifts. The dynamic checkout module can process a checkout request to purchase the gifts associated with each of the multiple recipients using a single credit card transaction. The delivery module electronically delivers the gifts to the multiple recipients. In some embodiments, the delivery module can electronically notify the multiple recipients if a delivery of the gift will not be electronic.

In accordance with at least one embodiment, the recipient search module can be configured to receive a search request from the user and access an associated recipient database to find one or more recipients that match the search request. In some embodiments, the user is a member of the social media platform. The social media platform can have a member database having stored thereon member information so that the associated recipient database includes the member database.

The product module can be configured to receive a product search request from the user and access the merchant database to find any of the plurality of gifts that satisfy the product search request. The message module can send an individualized message (e.g., selected and/or created by the user) to each of the multiple recipients.

The on-demand rendering module can be configured to provision one of the plurality of gifts from a first format into a second format. For example, the first format can be a value associated with a first merchant and the second format can be a value associated with a second merchant. As another example, the first format can be a sixteen digit code and the second format can be one selected from a group consisting of a 2-D bar code, a contactless device, and adding value to an existing card.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of an environment in which some embodiments of the present invention may be utilized;

FIG. 2 shows a flow chart illustrating exemplary operations in accordance with one or more embodiments of the present invention;

FIG. 3 is a block diagram with exemplary components of an electronic commerce system in accordance with various embodiments of the present invention;

FIG. 4 is a block diagram illustrating the interaction between exemplary components in accordance with some embodiments of the present invention;

FIG. 5 shows a flow chart with a set of exemplary operations for eGifting in accordance with one or more embodiments of the present invention;

FIG. 6 illustrates a screen shot illustrating an exemplary graphical user interface that may be used in various embodiments of the present invention;

FIGS. 7A-7B illustrate additional graphical user interfaces that may be used in some embodiments of the present invention;

FIG. 8 shows a flow chart with a set of exemplary operations for group gifting in accordance with one or more embodiments of the present invention;

FIG. 9 is a screen shot illustrating an exemplary graphical user interface for group gifting that may be used in various embodiments of the present invention;

FIG. 10 is a screen shot illustrating an exemplary graphical user interface for inviting others to participate in group gifting that may be used in various embodiments of the present invention;

FIG. 11 is a screen shot illustrating an exemplary graphical user interface for tracking group gifting in various embodiments of the present invention; and

FIG. 12 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to electronic commerce. More specifically, various embodiments of the present invention relate to a dynamic checkout process and/or group gifting. In some embodiments, the dynamic checkout process can be integrated with a social platform electronic commerce experience. According to some embodiments, an eGift social platform is provided that includes a dynamic checkout process that allows a user to select a single gift offer, multiple gift offers, and/or to create a basket of goods to send to one or multiple recipients. The dynamic checkout, in various embodiments, also allows the user to select the desired recipient(s) before, after, or intermixed with selecting the offers and/or creating the basket of goods. For example, once the offer has been defined by the user, the user can select the desired recipient(s). Similarly, once the desired recipient(s) have been selected by the user, the user can select or define offer(s) intended for the recipient(s). The defined offer(s) or gift(s) can include any physical item or virtual item. For example, the defined offer or gift could be a physical or virtual card that has a monetary value. As another example, the defined offer or gift could be a service such as a massage, cleaning, etc.

The delivery can be an electronic delivery or a physical delivery of the goods or products. For example, the delivery can also be delivered down to a mobile device and redeemed via SMS, EMAIL, BarCode or NFC (Near field communications). In some cases, the sender can select from one or more available delivery options. If the user selects an electronic delivery, the user can select a single recipient to an unlimited number of recipients using a social platform account (e.g., a Facebook account), a mobile number, and/or an email address for the delivery of this item. However, if the user selects physical delivery, then the sender, in some cases, will be prompted to enter the recipients mailing address. In other cases, the mailing address or physical address will be derived from the account information of the recipients using a member database within the social platform or from the hosting device (e.g., computer, cell phone, mobile platform, etc.). In some embodiments, the physical address, if available, can be automatically extracted from a contact list maintained in a social network user database.

For example, the user can browse an eGift marketplace and decide to buy a coffee product, a gift certificate redeemable at one or more merchants, an ice cream product, a music download, movie tickets, sporting event tickets, and other product. In some cases, the user can decide to make a contribution to a group gift. Once the item or contribution to the group gift is selected, the user can enter their user name and password. Next, the user can select the recipients, which can be at least one, and could be as many as 20 or more. Once the recipients are determined and the user selects the recipients or enters the recipients email address, social platform account ID, or mobile number, the check out process is completed by supplying a valid payment type. This one to many, one to one, or many to one checkout process creates a social or dynamic checkout process which eliminates the structured environment around sending goods and services to one individual. Dynamic checkout provides a mechanism in which one or more goods can be purchased from one or more merchants and delivered to one or more recipients either virtually or physically. Moreover, in this case, the eGift purchase process creates a mechanism for which goods can be delivered both virtually and physically to one or many recipients using a single payment. In some embodiments, the systems and method of the eGift marketplace allow for the one or more merchants to push out incentives or vouchers to the user. These incentives, for example, could be in response to the one or more goods that were purchase.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to social platforms such as Facebook, embodiments of the present invention are equally applicable to various other electronic commerce architectures, mobile commerce architectures, and structures outside of social media platforms such as businesses with an online and/or mobile presence.

For the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices and systems. More specifically, embodiments can utilize a variety of communication systems, services, and devices such as cell phone networks and compatible devices. In addition, embodiments are applicable to all levels of computing from the personal computer to large network mainframes and servers. The dynamic checkout process and group gifting applications may be a service available over the internet, mobile web or as a downloadable application. The service may also be available as a marketplace, on a single merchant website. In some embodiments, the services may be available via tablet or interactive TV.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### General Description

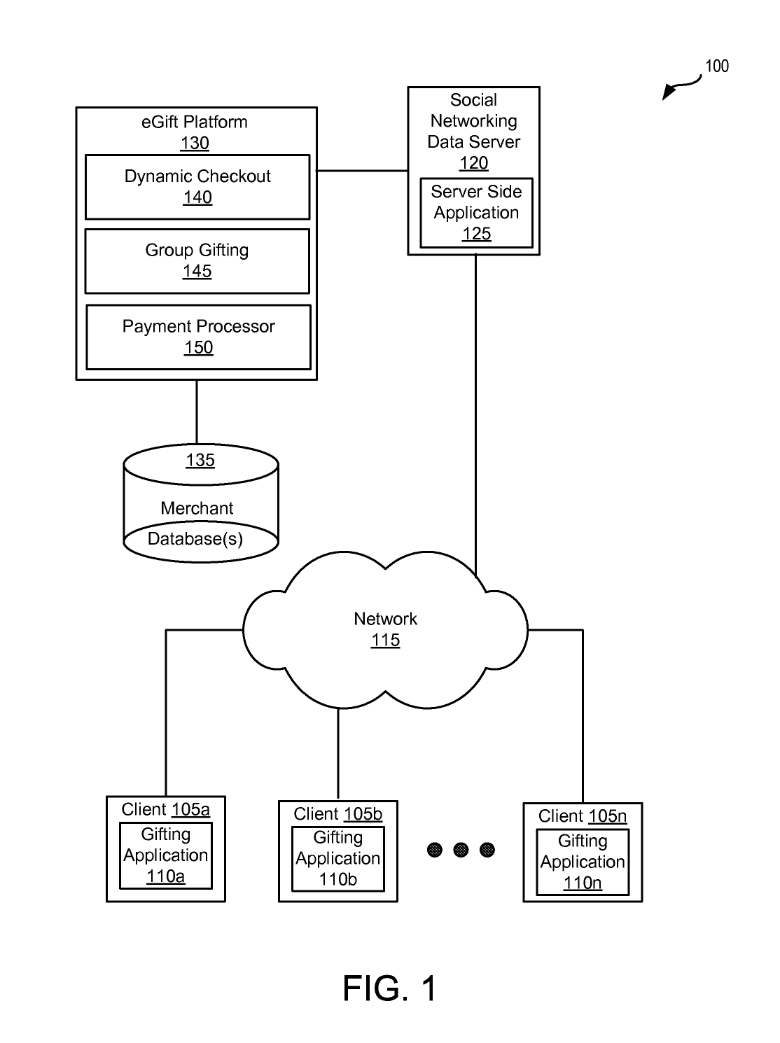

FIG. 1 illustrates an example of an electronic commerce environment 100 in which some embodiments of the present invention may be utilized. The embodiments illustrated in

FIG. 1 show clients 105a-105n running gifting application 110a-110n. Clients 105a-105n can be webpages, custom applications, and/or mobile devices running custom applications. Examples of mobile devices which can be used in accordance with various embodiments of the present invention include handheld devices (e.g., iPad), smartphones (e.g., iPhone, Android, Blackberry), PDAs, personal computers, ultra-mobile PCs, tablet PCs, laptops, and others.

The embodiments shown in FIG. 1, show network 115 connecting clients 105a-105n to social networking data server 120 running server side application 125. Network 115 can be any group of interconnected devices capable of exchanging information. In some embodiments, network 115 may be as few as several personal computers on a Local Area Network (LAN) or as large as the Internet. Network 115 may also be a Voice over Internet Protocol (VoIP) network or a Voice Response Unit (VRU) according to some embodiments of the present invention. In some cases, network 115 may be comprised of multiple networks (private and/or public), even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

Social networking data server 120 can store information regarding registered users and/or members of the social network. In some embodiments, social networking data server 120 stores a mobile number, an email address, physical address, mailing address, and/or a unique network identification of the users.

Communicably coupled to social networking data server 120 is eGift platform 130 which interacts with merchant database(s) 135. As shown in FIG. 1, eGift platform 130 includes dynamic checkout application 140, group gifting application 145, and payment processor 150. Dynamic checkout application 140 allows a user to search for, browse, and select a single gift offer, multiple gift offers, and/or to create a basket of goods to send to one or more recipients. This can be done, for example, through the use of one or more graphical user interface screens. According to various embodiments, the dynamic (or social) checkout process provided by dynamic checkout application 140 allows the user to select the desired recipient(s) before, after, or intermixed with selecting the offers and/or creating the basket of goods or contributions to group gifts. In some embodiments, the systems and methods are designed to automatically synchronize any changes to the user's gift bag in the browser to the backend server. This synchronization can occur seamless to the user by not requiring a page refresh or other user action.

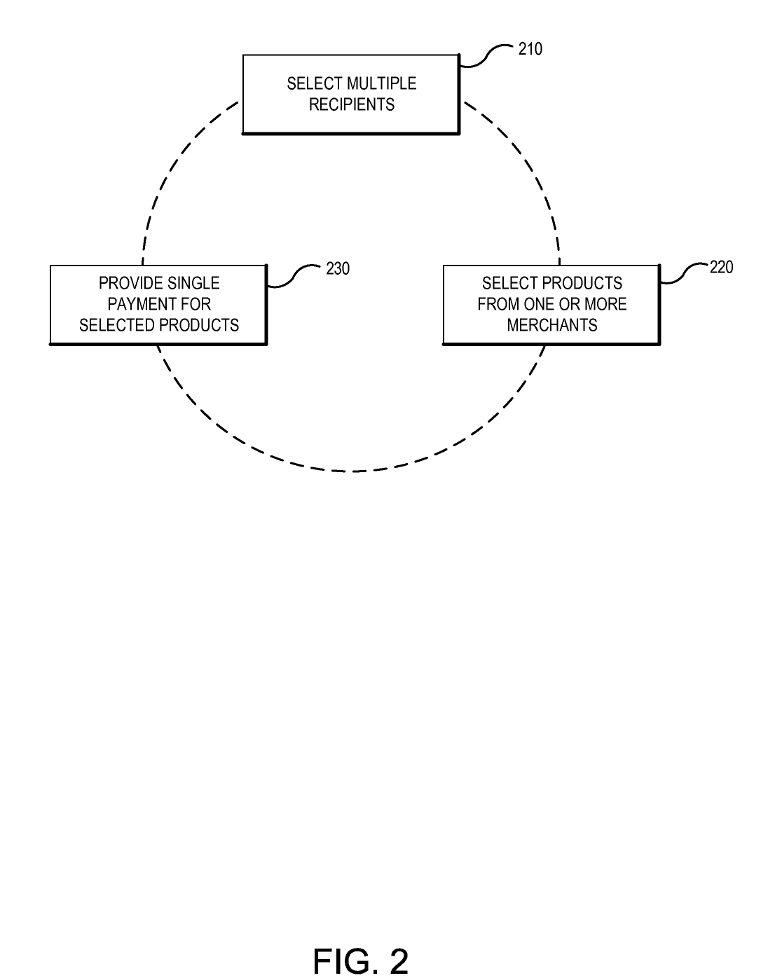

For example, the user can browse an eGift marketplace populated with offers provided by one or more merchants which are stored in merchant database(s) 135. As illustrated in FIG. 2, the user can select the recipient(s) first with recipient selection operation 210, the gift(s) or product(s) first with product selection operation 220, or some recipients, then some gifts, then some additional gifts and then some additional recipients. Once the recipients and gifts are associated as desired by the user using dynamic checkout application 140, the check out process is completed by supplying a valid payment type with payment operation 230 which is processed through payment processor 150. This one to many, one to one, or many to one checkout process creates a social or dynamic checkout process which eliminates the structured environment around sending goods and services to one individual that exists in traditional electronic commerce shopping carts and checkout applications.

In some embodiments, payment processor 150 may include one or more security features to score a transaction based on various transaction attributes. Examples of transaction attributes include, but are not limited to transaction amount, location, merchant identification, product quantities, service description, and/or other transaction attributes. Many transaction attributes can be sent through a scoring engine (e.g., in real-time) after authorization by a card issuer is obtained. Some of the attributes that may be included are the credit card number, purchase frequency, billing address, email address, telephone number, IP Geolocation or billing address relevant to shipping address.

The attributes may then be assigned a numerical value, indicator, or other ranking (e.g., low/mid/high) relative to the risk level of a purchase. Using this computed score (or other ranking) and/or the attributes directly, potentially fraudulent transactions can be determined. For example, the computed score can depend on various events exceeding a threshold value. In some embodiments, when exceeding a threshold value (e.g., 2, 5, or 10) for purchases with same billing address, a threshold value (e.g., 2, 5, or 10) for purchases with same email address, a threshold value (e.g., 2, 5, or 10) for purchases with same phone number, and/or a threshold value (e.g., 2, 5, or 10) for purchases with same credit card number. When these thresholds are exceeded a minimum score can be automatically assigned. Different minimum scores can be assigned for different events. For example, a higher score may be assigned when a number of purchases with the same IP address are exceeded. In some embodiments, payment processor 150 may place a hold for a period of time (e.g., one hour or more) before allowing the gift to be delivered. During this time, for example, the transactions could be manually or automatically reviewed for fraud.

Group gifting application 145 allows a user or organizer to setup a group gift (i.e., a gift with multiple contributors) for a desired recipient. For example, the organizer can invite others to contribute to a gift. The gift could be a surprise gift for a party, graduation, or any other event. In some embodiments, group gifting application 145 allows the organizer to set up the group gift up to 60 or more days in advance of delivery (physical or electronic) of the gift. The organizer can set specific goals, such as a dollar amount by a specific date. In some cases the organizer may ask for as much as possible to be raised by the specific date. Then, invitations can be sent to other contributors and money can be collected through payment processor 150. In some embodiments, the other contributors can invite additional individuals to participate in the group gift.

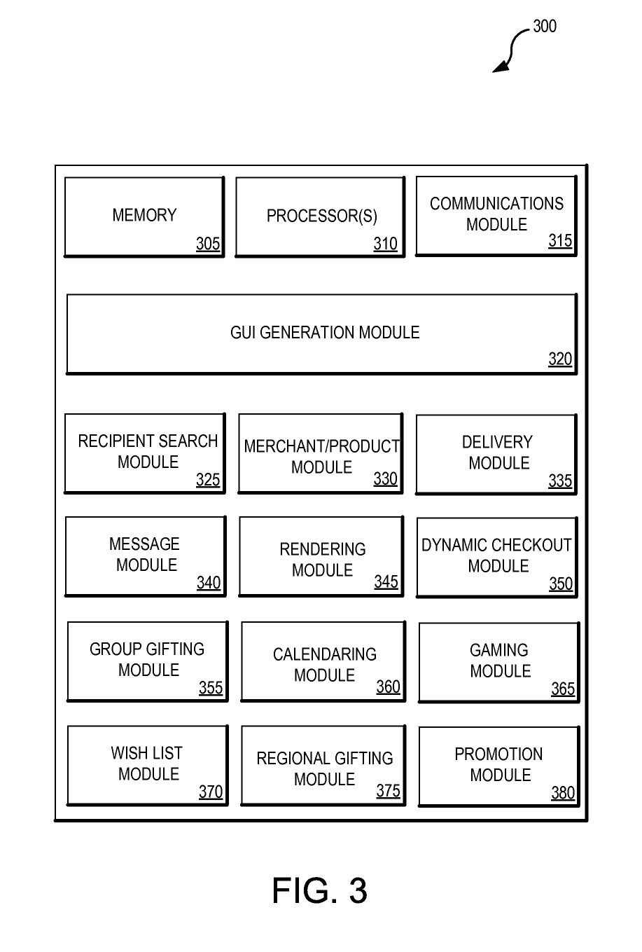

FIG. 3 shows a block diagram 300 with exemplary components of an electronic commerce system in accordance with various embodiments of the present invention. According to the embodiments shown in FIG. 3, the electronic commerce system 300 can include memory 305, one or more processors 310, communications module 315, graphical user interface (GUI) generation module 320, recipient search module 325, merchant/product module 330, delivery module 335, message module 340, rendering module 345, dynamic checkout module 350, group gifting module 355, calendaring module 360, gaming module 365, wish list module 370, regional gifting module 375, and promotion module 380. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, dynamic checkout module 350 can be separated into two or more modules for checkout and payment processing.

Memory 305 can be any device, mechanism, or populated data structure used for storing information. In accordance with some embodiments of the present invention, memory 305 can encompass any type of, but is not limited to, volatile memory, nonvolatile memory and dynamic memory. For example, memory 305 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 305.

Memory 305 may be used to store instructions for running one or more applications or modules on processor(s) 310. For example, memory 305 could be used in one or more embodiments to house all or some of the instructions needed to execute the functionality of communications module 315, graphical user interface (GUI) generation module 320, recipient search module 325, merchant/product module 330, delivery module 335, message module 340, rendering module 345, dynamic checkout module 350, group gifting module 355, calendaring module 360, gaming module 365, wish list module 370, regional gifting module 375, and/or promotion module 380.

According to various embodiments of the present invention, communications module 315 manages and translates any requests from a user (e.g., received through a graphical interface screen) or application into a format required by the destination component and/or system. Similarly, communications module 315 may be used for communications between modules and/or systems that use different communication protocols, data formats, and/or messaging routines. Communications module 315 may also be used in some embodiments for encrypting and decrypting the communication messages between modules, applications, components, and/or systems. For example, communications module 315 may encrypt/decrypt messages regarding the processing of the payment for the gifts. In addition, communications module 315 may be used to generate communications to other individuals (e.g., invitations for group gifting).

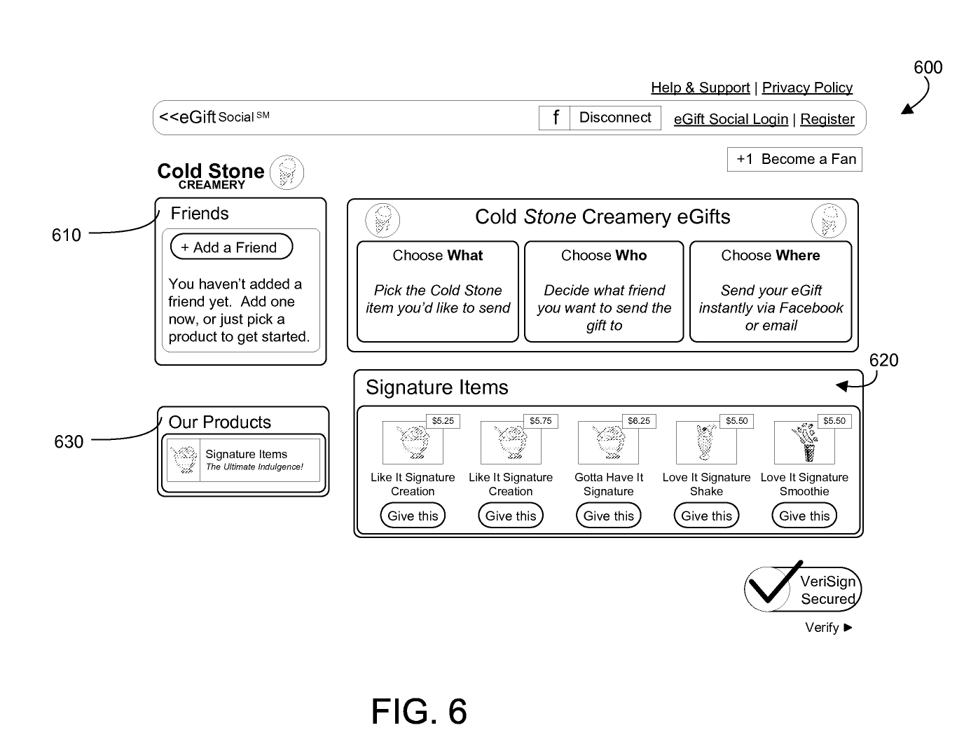

GUI generation module 320 can generate one or more user interface screens designed to receive user input to associate multiple recipients with one or more of the plurality of gifts. In at least one embodiment, GUI generation module 320 is used to create the GUI screens allowing a user to interact with eGift platform 130 and/or social networking data server 120. For example, GUI generation module 320 can be used to generate FIGS. 6, 7A-7B, and 9-11 discussed below that allows users to browse for gifts, select recipients, and generate group gifts. In some embodiments, GUI generation module 320 can generate a maintenance screen or window during a scheduled downtime. The maintenance window can be introduced to the consumer prohibiting anyone from accessing eGift social platform through the web or social platform (e.g., Facebook). In some embodiments, the automated maintenance window can be delivered when a server is down. In addition, a notification or alert may be generated and sent to management teams when the maintenance window is automatically displayed.

Recipient search module 325 receives a search request from the user (e.g., through a GUI screen created by GUI generation module 320 and translated through communications module 315). Using the search request, recipient search module 325 accesses one or more databases, such as an associated recipient database, to find one or more recipients that match the search request. For example, when the eGift platform is used in conjunction with a social media platform of which the user is a member, the social media platform can include a member database having stored thereon member information. Examples of member information can include, but is not limited to, first name, last name, nick name, user name, name of a spouse, name of a child, name of a parent, age, colleges and universities attended, high schools attended, hometown information, current city and state, and other information.

In some cases, recipient search module 325 creates or uses an interface application on a graphical user interface screen that displays friends of the user available through the social networking platform. The interface application can display some or all of the friends. In some cases, a search field can be included which allows input of one or more search criteria such as name, age, etc.

Merchant/product module 330 is configured to receive a product search request from the user. For example, the product search request can be received through a GUI screen created by GUI generation module 320 and translated through communications module 315. Once the product search request is received, merchant product module 330 can access the merchant database to find any of the plurality of gifts that satisfy the product search request. The product search request can be based on a variety of information such as, but not limited to, merchant, gift type, minimum cost, maximum cost, most recommended, and/or other criteria.

Once the merchant products and the recipients are selected and associated, delivery module 335 determines the type of delivery available for each of the products and/or recipients. In some embodiments, the sender can select a desired delivery method if more than one delivery option is available. For example, the products or gifts could be delivered electronically or physically delivered to the multiple recipients. If the user selects an electronic delivery, the delivery could occur via a social platform account (e.g., a Facebook account), a mobile number, and/or an email address. However, if the user selects physical delivery, then the sender, in some cases, will be prompted to enter the recipients mailing address. In other cases, the mailing address will be derived from the account information of the recipients using a member database within the social platform. This delivery information can then be used by delivery module 335 to ensure the products are properly delivered once payment is received.

Message module 340 allows the sender to individualize messages to each of the multiple recipients. For example, the individualized message to each recipient can be created by the user through text field available on a graphical user interface screen. In some embodiments, the individualized messages can be selected through a set of preset messages that are available for selection through a drop down menu on a graphical user interface screen.

As described above, delivery module 335 determines the type of delivery available for each of the products and/or recipients and ensures that the gifts are properly delivered. In some embodiments, rendering module 345 can be used to provision one of the plurality of gifts from a first format into a second format. The rendering can occur at the request of the delivery module 335 or from one of the recipients after the gift has been delivered. Examples of the types of formats include, but are not limited to, a sixteen digit code, a 2-D bar code, a contactless device, and adding value to an existing card. As another example, the first format could be a value associated with a first merchant and the second format could be a value associated with a second merchant. Still yet, the first format can be a sixteen digit code and the second format can be a 2-D bar code, a contactless device, or adding value to an existing card.

Dynamic checkout module 350 processes a checkout request to purchase the one or more of the plurality of gifts associated with each of the multiple recipients using a single credit card transaction. For example, dynamic checkout module 350 can receive a checkout request with payment for multiple products from multiple merchants. In some cases, the checkout request contains information regarding the merchants that need to be paid and the amount that needs to be paid to each merchant. For example, the checkout request in some embodiments includes a merchant identification string, a total amount, and a percentage to be paid to each merchant. In other embodiments, the checkout request includes a merchant identification string associated with a specific amount to be paid to each merchant and the taxes that need to be collected.

In some embodiments, the dynamic checkout module can be provided by a separate entity from the merchant. As a result, in this case, the separate entity would be listed as the merchant of record. The settlement of the payment could occur, for example, using a prepaid platform and FDNET to each merchant partner participating in the marketplace using a batch process and making payment via ACH.

Group gifting module 355 can allow a consumer to set himself up as an organizer of a group gift for a selected recipient. In some embodiments, the organizer can suggest a goal amount (e.g., fifty dollars, two hundred dollars, etc) for a gift, leave an open goal for users to contribute as much as possible, or select a specific gift (e.g., from a wishlist or directly from a merchant inventory management system). In some cases, the organizer can select a gift card style and delivery date for the group gift. The organizer can also suggest and invite other contributors to participate in the group gift. In some embodiments, the invitations may be generated and sent using communications module 315. The invitations could be sent via email or through a social platform. Group gifting module 355 monitors gifts or payments submitted by the organizer and other contributors. The gifts may be submitted using a credit card payment for the amount that a contributor wants to give toward the group gift. Once a delivery date has been reached, the group gift will close and the gift will be delivered to the recipient. For example, if the gift is a gift card, the delivery can be either a physical card or virtual card.

In some embodiments, group gifting module 355 allows the contributors the ability to upload photos, music, create customized cards (e.g., birthday cards), customize the colors, add a gift wrap and/or bow to the group gift. This allows the delivery of the group gift to be unique to the sender. In addition, this allows the sender the ability to send a “present” and the recipient to “open” the package (e.g., on a flash page) to view the gift. In addition, group gifting module 355 can allow merchants the ability to create unique storefronts, unique messaging, and/or unique branding throughout experience. In some embodiments, the recipient can opt out of commercial merchant messaging within a gift notification.

Calendaring module 360 can allow the senders or recipients to login to eGift social platform and setup their private settings for scheduling and/or prompting of gifts by date, event, status changes, merchant, and/or the intended recipients. For example, calendaring module 360 can be used to generate reminders/prompts for the user to schedule a gift for a friend's birthday. In some cases, the user can set parameters for receiving notifications of all birthdays in advance (e.g., a week in advance, thirty days in advance, at the beginning of the month, etc). In some cases, calendaring module 360 automatically monitors for changes to a status within a social platform. Upon detecting the change, the event could be automatically added to a sender's calendar for future reminders. As another example, calendaring module 360 can monitor friends that have merchant fan pages and send reminders asking if the individuals have purchased a merchant gift card lately.

Gaming module 365 allows gift givers and receivers to each earn rewards (e.g., points, badges, and/or prizes) for various activities or after meeting criteria for moving among different levels. For example, in some embodiments gift givers and receives can earn rewards for being the best, most frequent, or most generous gift giver/receiver. As another example, gaming module 365 may distribute rewards for based on a score for overall usage of the gift givers/recipient, merchant specific purchases, and/or specific products or item gifted. These points, badges, and/or prizes can be publicly displayed within the social platform of the participants. In some cases, the rewards can be exchanged through one or more of the merchants.

Wish list module 370 can allow individuals to login to the eGift social platform and create a wish list of their favorite stores, items, gift cards and/or values. In some embodiments, once a recipient is selected, group gifting module 355 can access wish list module 370 and retrieve a list of the recipient's favorite stores, items, gift cards and/or values. GUI generation module 320, for example, can use this information to populate a list for the organizer to select from.

Regional gifting module 375 allows organizers the ability to search to see which merchants are close to a recipient. In some embodiments, when the organizer enters the recipient's information, a list of merchants in their vicinity could appear in a list. In other embodiments, the organizer could search for merchants near a recipient. These merchants returned can be sorted and displayed based upon a variety of different criteria. For example, in some embodiments, the merchants can be sorted and displayed based on merchant category, age appropriateness, location, etc.

Promotion module 380 allows the merchants to offer promotions by either gifting the sender with a voucher or discount. In some cases, the promotion module 380 allows the merchants to push a promotion to their customers. A merchant and/or eGift can reward consumers for specific behaviors (i.e. buy one gift card get a gift card, buy one product get a product, by a gift card/product for a % off, etc.) In some embodiments, the rewards can be based on a voucher based promotion per transaction (e.g., receive a $2.00 voucher for every transaction), by minimum amount spent (e.g., receive a $1.00 voucher for spending a minimum of $10.00, receive a $3.00 voucher for spending a minimum of $20.00, receive a $5.00 voucher for spending a minimum of $30.00, etc), or minimum number of units purchased (e.g., receive a $3.00 voucher for purchasing a minimum of three gift cards). In other embodiments, the rewards can be a discount based promotion per transaction (e.g., receive a 20% discount on every transaction, buy a $5.00 gift card for only $4.00, etc), by minimum amount spent (e.g., receive a 5% discount for spending a minimum of $20.00, buy a $20.00 gift card for only $19.00, receive a 10% discount for spending a minimum of $30.00, buy a $30.00 gift card for only $27.00, receive a 20% discount for spending a minimum of $50.00, buy a $50 gift card for only $40.00, etc), by minimum number of units purchased (e.g., receive a 10% discount for purchasing a minimum of three gift cards, buy three $5.00 gift cards for only $13.50, etc).

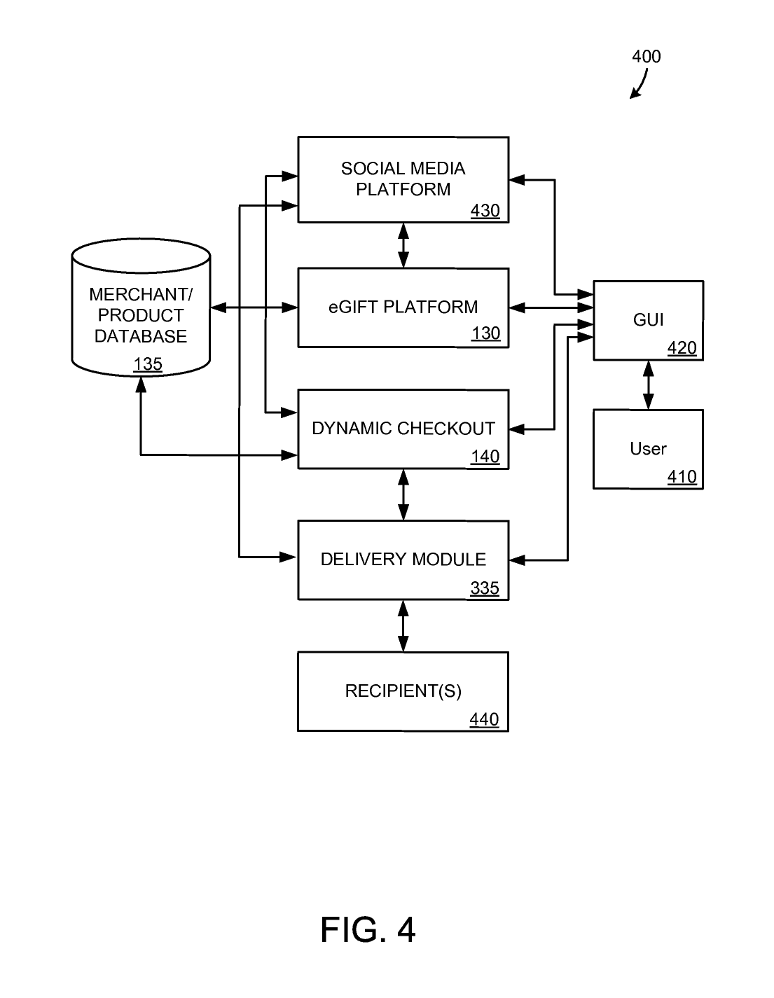

FIG. 4 is a block diagram illustrating the interaction between exemplary components in accordance with some embodiments of the present invention. User 410 wants to send a gift or set of gifts using eGift platform 130 that is available through social media platform 430 (e.g., Facebook). User 410 can interact with one or more graphical user interface screens 420 to browse and select the available gifts stored in merchant product database 135, select the recipients from among a plurality of members of the social media platform 430, and select a delivery method determined to be available by delivery module 335 which delivers the selected gifts to recipient(s) 440. Once the recipients and gifts are associated as desired by the user using dynamic checkout 140, the check out process is completed by supplying a valid payment type. Using a graphical user interface screen 420 interacting with dynamic checkout 140, the user can select the recipient(s) first with recipient selection operation, the gift(s) or product(s) first, or some recipients, then some gifts, then some additional gifts and then some additional recipients.

In some embodiments, the recipient of a gift can be shown in the public feed or message board of the social media platform 430. As such, all the followers of the feed are allowed to see that the recipient received a gift from a sender. If the recipient of the gift includes a link, then anyone who clicks on the link who is not the recipient is directed to the merchant website.

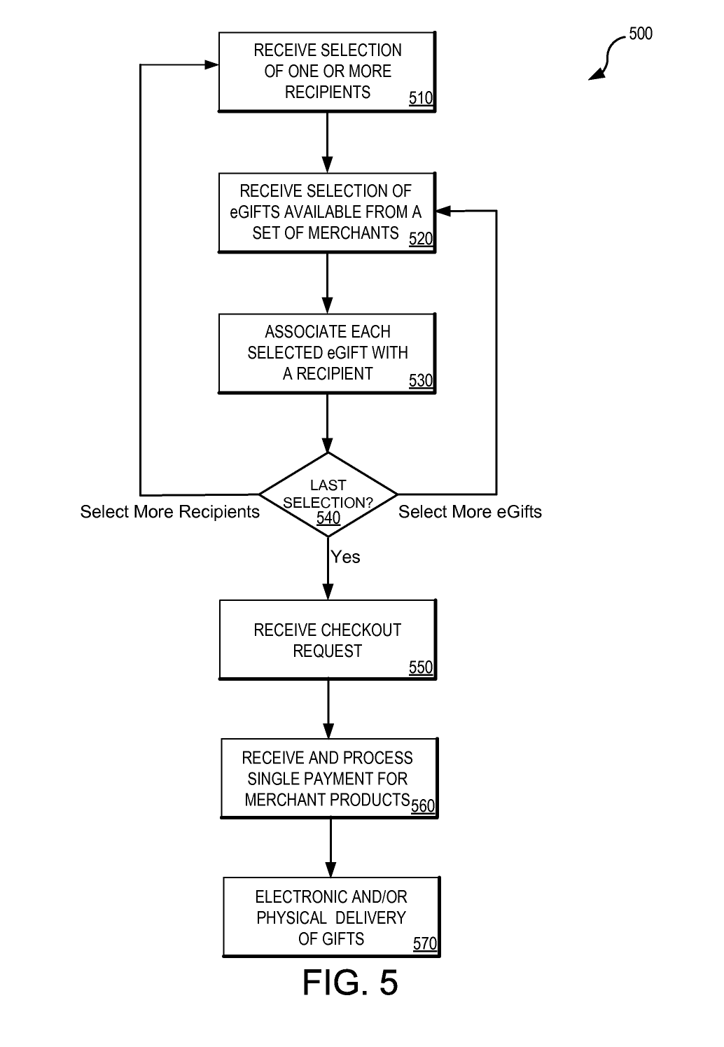

FIG. 5 shows a flow chart 500 with a set of exemplary operations for eGifting in accordance with one or more embodiments of the present invention. In the embodiments shown in FIG. 5, recipient selection operation 510 receives a selection of one or more recipients to which a user desires to send a gift. Gift selection operation 520 receives a selection of gifts available from a set of merchants. Association operation 530 allows the user to associate a selected gift with one or more recipients.

Additional selection operation 540 determines if the last selection of gifts and/or recipients has been made by the user. In some embodiments, the last selection is indicated when the user submits a checkout request through a GUI screen. If additional selection operation 540 determines that the user wants to select one or more additional recipients, additional selection operation 540 branches to recipient selection operation 510 which receives a selection of one or more recipients. If the user wants to select one or more additional gifts, additional selection operation 540 branches to gift selection operation 520.

Once the last selection is indicated, then additional selection operation 540 branches to checkout request operation 550 which monitors for a checkout request to purchase the one or more of the plurality of gifts associated with each of the multiple recipients using a single credit card transaction. Once the request is received, processing operation 560 processes the checkout request using a single credit card transaction. The gifts are electronically or physically delivered through delivery operation 570.

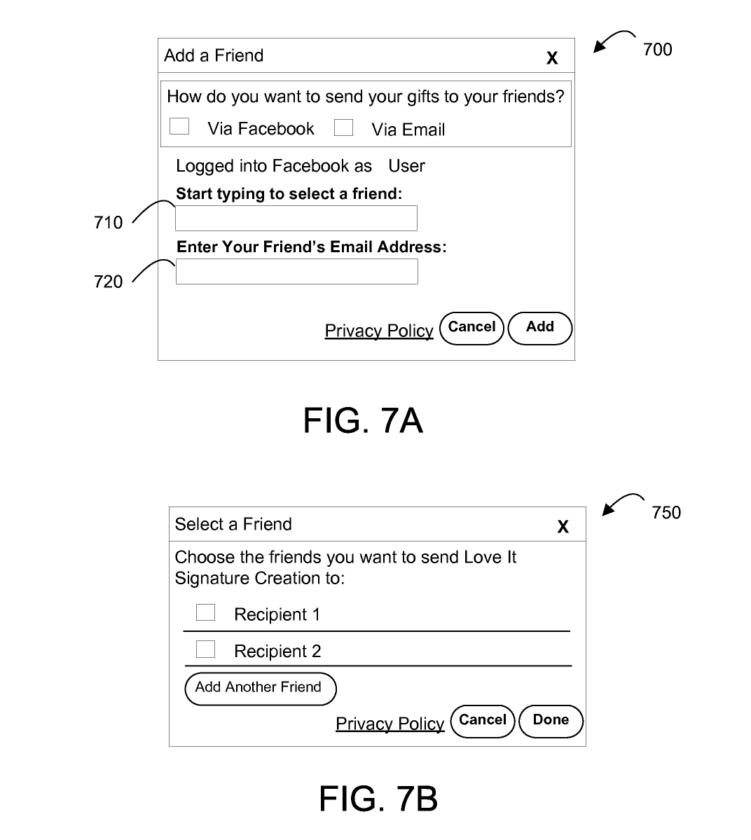

FIG. 6 illustrates a screen shot illustrating an exemplary graphical user interface 600 that may be used in various embodiments of the present invention. More specifically, FIG. 6 shows a graphical user interface screen using eGift platform 130 via Facebook. In the embodiments illustrated in FIG. 6, a user can select a Facebook friend using friend selection screen 610. When the user selects the “Add a Friend” button within friend selection screen 610, one or more searching and selection mechanisms such as a text field, interactive list, radio buttons, and the like are provided. For example, FIG. 7A illustrates a friend selection screen 700 with bounding boxes 710 and 720 that allow for a search by name or e-mail address.

GUI screen 620 allows the user to select a product, such as an ice cream. Once a product is selected, an association screen is displayed that allows the user to select the recipients for that product. FIG. 7B shows one example of association screen 750.

The products for a particular merchant can be grouped into one or more categories. These categories can be displayed in selection screen 630. The user can pick which categories of products by selecting one of the groupings within selection screen 630. In some cases, selection screen 630 includes groupings from different merchants.

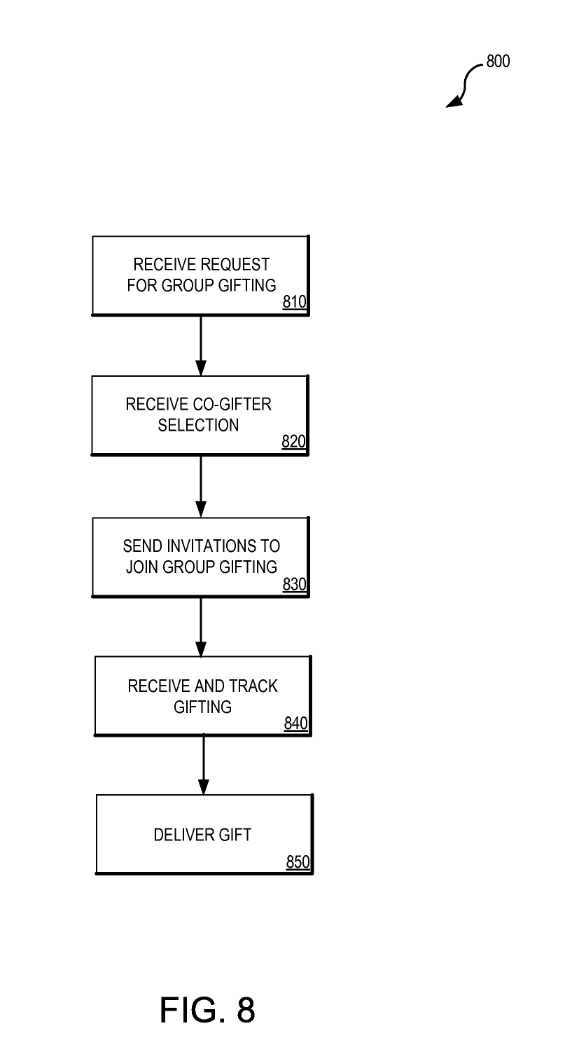

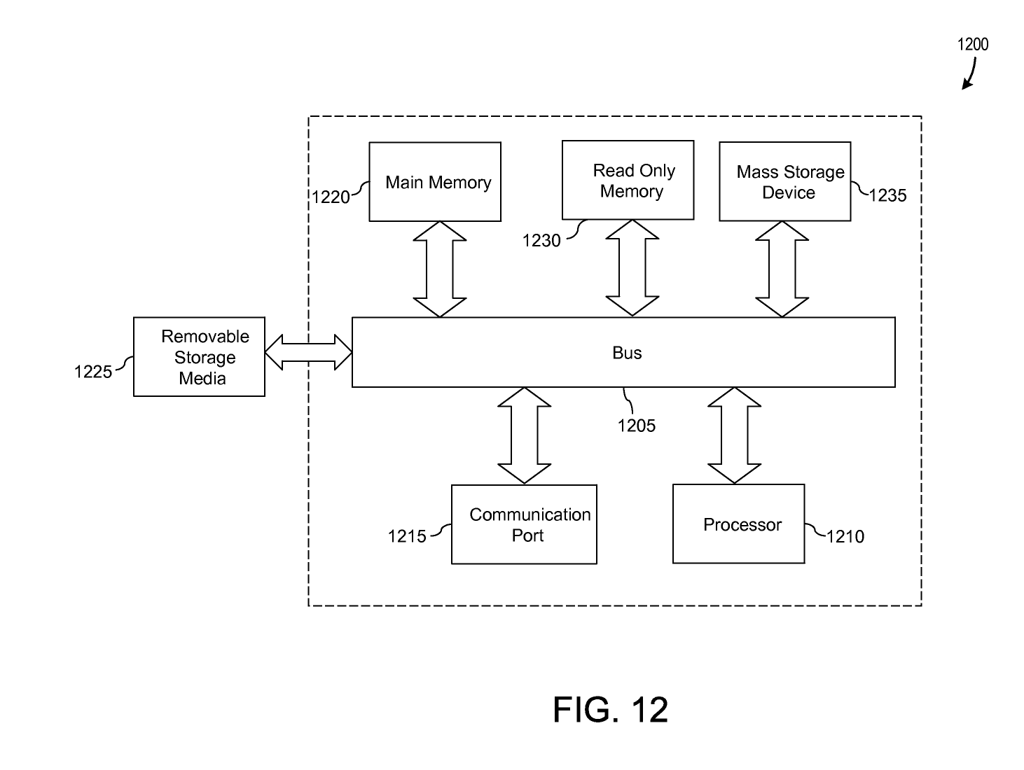

FIG. 8 shows a flow chart with a set of exemplary operations for group gifting in accordance with one or more embodiments of the present invention. In some embodiments, these operations may be performed by eGift Platform 130 or one or more components and/or modules illustrated in FIG. 3 and/or FIG. 12. As illustrated in FIG. 8, initialization operation 810 receives a request for group gifting. An organizer can generate the request, for example, through a graphical user interface generated by GUI generation module 320 and select one or more co-gifters or additional contributors. Receiving operation 820 receives the one or more co-gifters or additional contributors selected by the organizer. In response to receiving the one or more co-gifters or additional contributors, invitation operation 830 sends an invitation to join the group gift. These invitations, for example, may be sent by e-mail, through a communication system within a social platform, text message, through fax, postal mail, automated telephone message, or by any other way of communication. After receiving the invitations, tracking operation 840 tracks any contributions (e.g., monetary donations, pictures, messages, etc) received. After a specific gifting goal (e.g., $500) is reached, or at a specified date, the gift and contributions are delivered to the recipient with delivery operation 850.

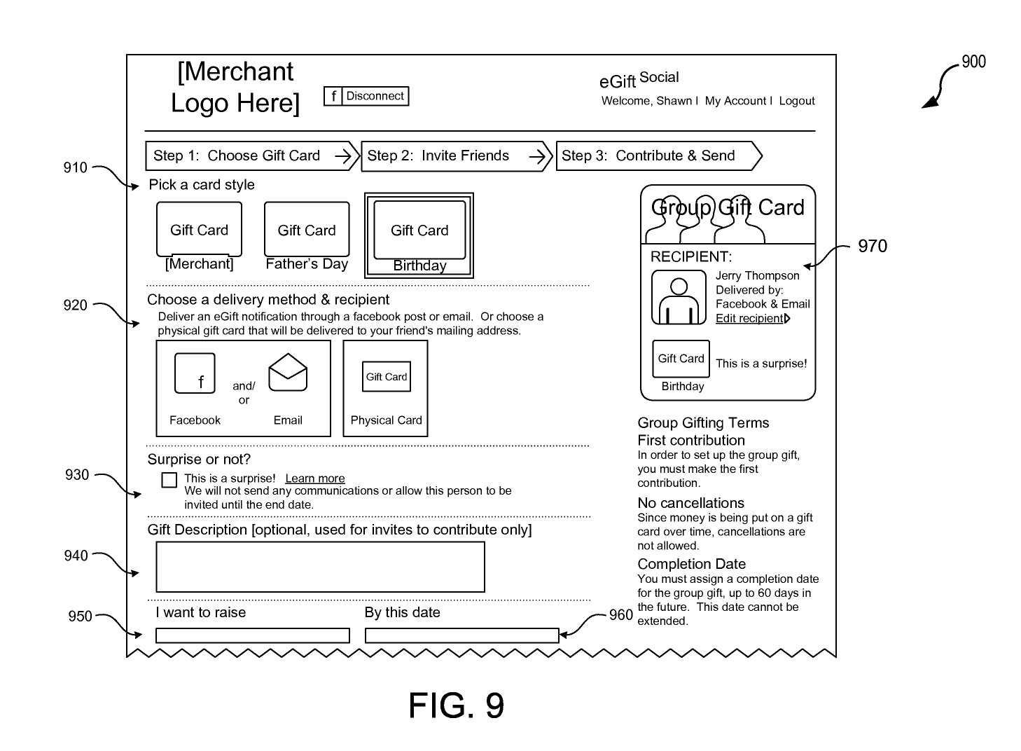

FIG. 9 is a screen shot illustrating an exemplary graphical user interface 900 that may be generated by GUI generation module 320 for organizing a group gift in various embodiments of the present invention. As illustrated in FIG. 9, the graphical user interface is generated through a social platform (e.g., Facebook). Interface 900 includes style selection area 910 that allows the organizer to select a gift card style (e.g., from a particular merchant or associated with a special occasion). In some embodiments, a particular gift or set of gifts from a merchant or set of merchants may be selected. For example, a wishlist area (not shown) may include one or more gifts from merchants that the recipient has added to a wish list maintained by wishlist module 370. If enough is not raised to purchase the selected item from the wishlist a gift card could be automatically generated with a note indicating that the gift card that the gifters were trying to raise enough money for the selected item from the wishlist.

Delivery area 920 allows a user to select the delivery method (e.g., through a social platform, via e-mail, or a physical delivery). Surprise area 930 allows the organizer to indicate whether this group gift is a surprise. By indicating that the group gift is a surprise, the eGifting platform will not send any communications to the recipient until the delivery of the gift. Description area 940 allows the organizer to enter comments that will be viewed by the other co-gifters. For example, description area 940 can be used to describe the reason for the gift or to request that certain photos or memories be provided by the other gifters. In addition, the organizer can set a financial goal and a completion date in contribution field 950 and date field 960. Summary area 970 summarizes the selections made by the organizer.

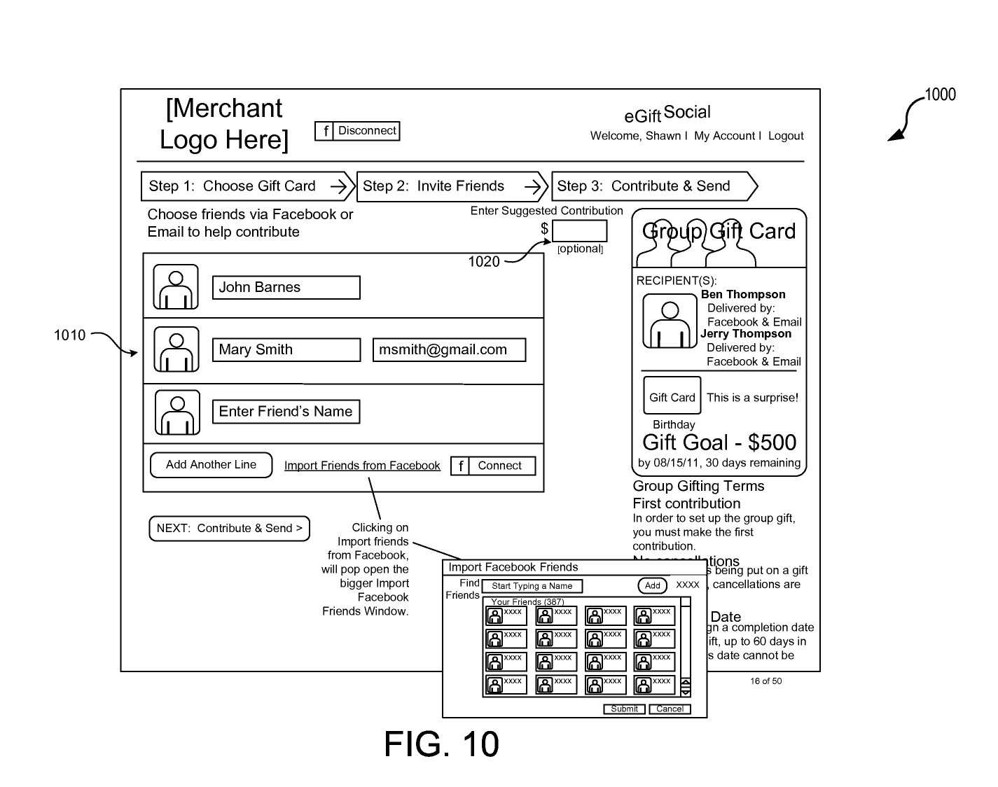

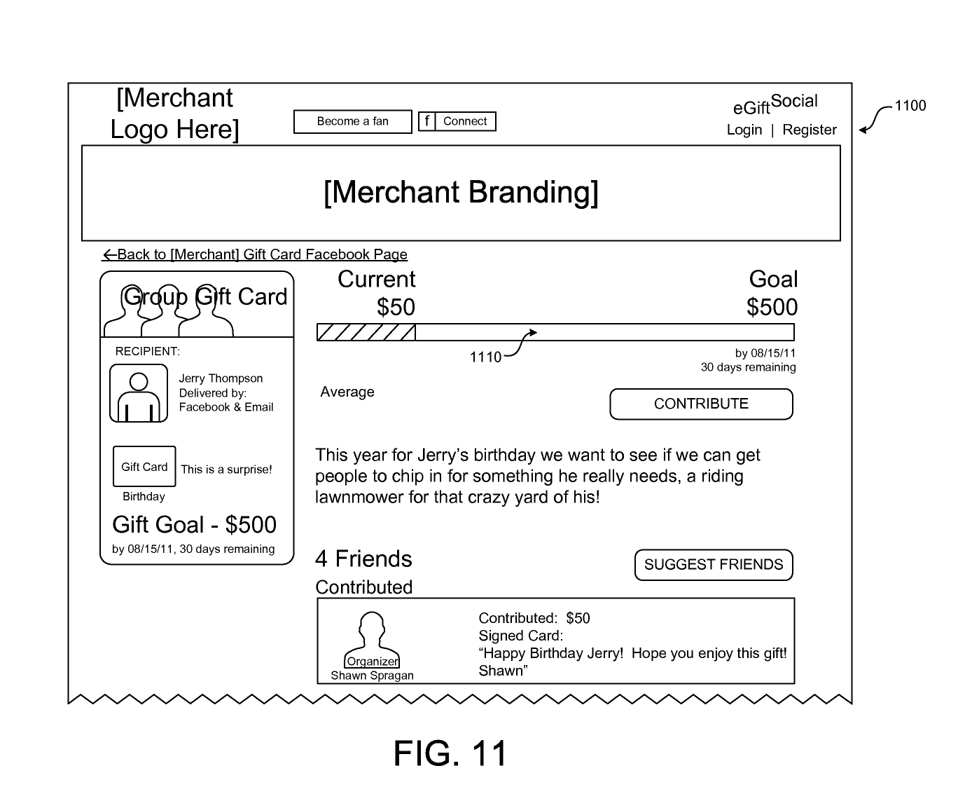

FIG. 10 is a screen shot illustrating an exemplary graphical user interface 1000 for inviting others to participate in group gifting that may be used in various embodiments of the present invention. Information regarding various individuals can be provided directly by the organizer or can be retrieved or imported from a social platform such as Facebook as seen in invitation area 1010. The organizer can suggest a contribution amount to be included with the invitations with contribution box 1020. Once the other participants have been selected, exemplary graphical user interface 1100 can be used for tracking group gifting in various embodiments of the present invention. As shown in FIG. 11, the graphical user interface 1100 can include a status indicator 1110 showing the current amount of contributions, the deadline for contributing, the contribution goal, and/or other information related to the group gift.

### Exemplary Computer System Overview

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 12 is an example of a computer system 1200 with which embodiments of the present invention may be utilized. According to the present example, the computer system includes a bus 1205, at least one processor 1210, at least one communication port 1215, a main memory 1220, a removable storage media 1225, a read only memory 1230, and a mass storage 1235.

Processor(s) 1210 can be any known processor, such as, but not limited to, an Intel® Itanium® or Itanium 2® processor(s), or AMD® Opteron® or Athlon MP® processor(s), or Motorola® lines of processors. Communication port(s) 1215 can be any of an RS-232 port for use with a modem based dialup connection, a 10/100 Ethernet port, or a Gigabit port using copper or fiber. Communication port(s) 1215 may be chosen depending on a network such a Local Area Network (LAN), Wide Area Network (WAN), or any network to which the computer system 1200 connects.

Main memory 1220 can be Random Access Memory (RAM), or any other dynamic storage device(s) commonly known in the art. Read only memory 1230 can be any static storage device(s) such as Programmable Read Only Memory (PROM) chips for storing static information such as instructions for processor 1210.

Mass storage 1235 can be used to store information and instructions. For example, hard disks such as the Adaptec® family of SCSI drives, an optical disc, an array of disks such as RAID, such as the Adaptec family of RAID drives, or any other mass storage devices may be used.

Bus 1205 communicatively couples processor(s) 1210 with the other memory, storage and communication blocks. Bus 1205 can be a PCI /PCI-X or SCSI based system bus depending on the storage devices used.

Removable storage media 1225 can be any kind of external hard-drives, floppy drives, IOMEGA® Zip Drives, Compact Disc-Read Only Memory (CD-ROM), Compact Disc-Re-Writable (CD-RW), and/or Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for an electronic commerce system with a dynamic checkout, group gifting, and/or other features. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method comprising:
displaying an interactive product list that includes a plurality of gifts that can be purchased by a user;
receiving selection information identifying multiple recipients to which the user desires to send one or more gifts;
associating each of the multiple recipients with at least one gift selected by the user through the interactive product list;
processing a checkout request to purchase the gifts associated with each of the multiple recipients using a single credit card transaction; and
electronically distributing the gifts to the multiple recipients upon approval of the single credit card transaction.

2. The method of claim 1, wherein the multiple recipients are members of an internet-based social networking site and electronically distributing the gifts occurs through the social networking site.

3. The method of claim 1, wherein the plurality of gifts that can be purchased by the user include gift certificates redeemable at one or more merchants, a coffee product, an ice cream product, a music download, and movie tickets.

4. The method of claim 1, wherein electronically distributing the gifts includes sending the gifts to each of the multiple recipients through a mobile phone, an internet-based social networking site, or an e-mail address.

5. The method of claim 1, wherein the gifts electronically distributed to the multiple recipients are from at least two different merchants and processing the checkout request includes apportioning payment to the at least two different merchants.

6. The method of claim 1, further comprising:
presenting a rendering option to each of the multiple recipients, wherein the rendering option is based on a merchant associated with the gift;
receiving a selection from one of the multiple recipients that the electronically delivered gifts be rendered as a 2-D barcode, rendered as a sixteen digit number, associated with an existing gift card, or associated with a contactless device; and
rendering the electronically distributed gifts in the rendering option selected.

7. The method of claim 1, further comprising:
receiving an on-demand provisioning request from one of the multiple recipients to provision one of the gifts from a first format into a second format; and
processing the on-demand provisioning request.

8. A system comprising:
a merchant database having stored thereon a plurality of gifts that are each associated with a merchant;
a graphical user interface module configured to generate one or more user interface screens configured to receive user input to associate multiple recipients with one or more of the plurality of gifts;
a dynamic checkout module configured to process a checkout request to purchase the one or more of the plurality of gifts associated with each of the multiple recipients using a single credit card transaction; and
a delivery module configured to electronically delivery the one or more of the plurality of gifts to the multiple recipients.

9. The system of claim 8, further comprising a recipient search module configured to receive a search request from the user and access an associated recipient database to find one or more recipients that match the search request.

10. The system of claim 9, further comprising:
a social media platform of which the user is a member, the social media platform including a member database having stored thereon member information; and
wherein the associated recipient database includes the member database.

11. The system of claim 8, further comprising a product module configured to receive a product search request from the user and access the merchant database to find any of the plurality of gifts that satisfy the product search request.

12. The system of claim 8, further comprising a message module to send an individualized message to each of the multiple recipients.

13. The system of claim 8, further comprising an on-demand rendering module configured to provision one of the plurality of gifts from a first format into a second format.

14. The system of claim 13, wherein the first format is a value associated with a first merchant and the second format is a value associated with a second merchant.

15. The system of claim 13, wherein the first format is a sixteen digit code and the second format is one selected from a group consisting of a 2-D bar code, a contactless device, and adding value to an existing card.

16. A computer-readable storage medium containing a set of instructions to cause one or more processors to:
receive selection information regarding multiple recipients to which a user desires to send one or more gifts;
associate each of the multiple recipients with at least one gift that has been selected by the user through an interactive product list;
process a checkout request to purchase the gifts associated with each of the multiple recipients using a single credit card transaction; and
electronically distribute the gifts to the multiple recipients upon approval of the single credit card transaction.

17. The computer-readable storage medium of claim 16, wherein electronically distributing the gifts includes sending the gifts to each of the multiple recipients through a mobile phone, an internet-based social networking site, or an e-mail address.

18. The computer-readable storage medium of claim 16, wherein the set of instructions further cause the one or more processors to:
present a rendering option to each of the multiple recipients, wherein the rendering option is based on a merchant associated with the gift;
receive a selection from one of the multiple recipients that the electronically delivered gifts be rendered as a 2-D barcode, a sixteen digit number, associated with an existing gift card, or associated with a contactless device; and
render the electronically distributed gifts in the rendering option selected.

19. The computer-readable storage medium of claim 16, wherein the set of instructions further cause the one or more processors to:
generate a first graphical user interface screen through an internet-based social networking site, the first graphical user interface screen including a recipient selection interface integrated with the internet-based social networking site to receive the selection information regarding multiple recipients to which the user desires to send one or more gifts; and
generate a second graphical user interface screen with the interactive product list, the second graphical user interface screen to receive gift search requests and inputs to select at least one gift for each of the multiple recipients.

20. The computer-readable storage medium of claim 19, wherein the set of instructions further cause the one or more processors to:
generate a third graphical user interface screen, the third graphical user interface screen including a delivery selection interface to receive inputs from the user to select the delivery method from one or more delivery options, and
wherein the delivery method options include mobile device delivery, e-mail delivery, and internet-based social networking site delivery.
